(19) United States
(12) Patent Application Publication
(10) Pub. No.: US 2005/0031752 A1
(43) Pub. Date: Feb. 10, 2005

(54) Three-dimensional cake sculpture method and product

(76) Inventor: Debra L. Koplish, West Milford, NJ (US)

Correspondence Address: Kenneth P. Glynn, Esq.;Glynn & Associates, P.C., 24 Mine Street, Flemington, NJ, 08822, US

(21) Appl. No.: 10/635,350

(22) Filed: Aug. 6, 2003

(51) Int. Cl. A23P 1/00

(52) U.S. Cl. 426/549; 426/383

(57) ABSTRACT

The present invention is a three dimensional cake sculpture product. The term “cake sculpture” refers to any cake that has a sculpture presentation. “Cake” means a product that is made from batter and is baked. The present invention product includes: a.) an edible baked base having a bottom, substantially vertical walls, and a non-vertical top; and, b.) an edible three dimensional sculpture presenting a distinguishable scene, the sculpture has two portions, being a first portion and a second portion. The first portion is three dimensional and is located on the non-vertical top of the base, and the second portion is two dimensional and is located on the substantially vertical walls of the base. In some preferred embodiments, the second portion includes at least one edible substrate and at least one edible printed segment of the distinguishable scene on the substrate.

### BACKGROUND OF THE INVENTION

1. Field of the Invention

The present invention relates to baked products, and, more particularly, to baked products having unique three dimensional presentations of scenes, e.g. stylized busts, animals, holiday themes, and the like. The present invention is both the method and the product, wherein the top has a three dimensional presentation and the side has a continuation of the presentation in two dimensions.

2. Information Disclosure Statement

The following patents relate to decorative baked products:

U.S. Pat. No. 2,895,832 describes a novelty cake comprising a baked cake having a recess in its upper surface, an edible sheet bearing an edible design applied on the surface of said sheet disposed in said recess, and a layer of transparent gelatin disposed over said sheet and filling most of the recess in said cake.

U.S. Pat. No. 3,503,345 describes a method for decorating a cake by pre-forming a disk of icing, freezing the disk so that it hardens to facilitate handling, and then placing it on the cake so that it softens to from the top of the cake.

U.S. Pat. No. 4,285,978 describes a method whereby decorative designs and the like can be formed upon baked goods by transferring a preprinted design from a transfer material to an uncooked dough surface. In one embodiment the dough surface is first covered with a thin layer of flour preparatory to transferring a water-soluble ink design to the dough. In a preferred embodiment after the dough is baked a liquid glaze is applied to the surface thereof for imparting a decorative and protective coating to the baked goods. The process of the invention is suitable for both hand and automated operation.

U.S. Pat. No. 5,035,914 describes a food for snack or as use as a breakfast cereal which has a creamy-orange flavor. The food product includes a popped cereal which is selected from oat, wheat, rye, soy, corn, rice and combinations of these and essentially includes a powdered dairy or dairy substitute product which simulates cream flavor in combination with powdered orange or artificial orange flavor. Preferred embodiments include sweeteners such as fructose, sugar, corn syrup, dextrose, artificial sweeteners and combinations of these. Further, the food may include preservatives as well as vitamin and mineral supplements. In one embodiment, the puffed cereal is formed in a shape of a sphere.

U.S. Pat. No. 5,534,281 describes an apparatus and a method for making printed foods such as cookies, crackers, and snacks at high production speeds on a continuous basis. The apparatus includes a rotary printer which is synchronized with dough forming apparatus such as a rotary cutter or rotary molder.

U.S. Pat. No. 6,295,758 describes a wrapper for wrapping about a floral grouping and a method for wrapping the floral grouping, the wrapper having a handle formed from a portion of the sheet of material for carrying the wrapper with the floral grouping disposed therein. The wrapper may comprise one or more sheets of material. The sheet may have more than one handle portion formed thereon.

U.S. Pat. No. 6,432,461 describes an edible cake decoration comprising a sugarpaste formulation including at least one humectant. A method of forming the decoration is also disclosed which includes exposing the sugarpaste to a humid environment. An apparatus for use in the method is also disclosed which comprises a blister having a profiled surface and plurality of ventilation holes therein, which blister forms a template for use in the vacuum forming of the wet sugarpaste to provide a 3-D shape to the decoration, the sugarpaste being dried after vacuum forming.

U.S. Pat. No. 6,432,462 describes edible decorations which reproduce all types of patterns, including colored patterns. The purpose of these decorations is partially or totally to cover the cakes for which they are intended and with which they form a perfectly homogenous whole. More precisely, the invention comprises in producing a printed decoration with five successive layers: a first layer of printed edible paper, and a second layer of material for modifying the texture of the edible paper and sticking the first and third layers together. The third layer comprises of a material belonging to the group comprising almond paste and chocolate. The fourth layer is equivalent to the second layer, and the fifth layer is equivalent to the first layer. By virtue of this innovation, a printed decoration does not detract from the cake and remains supple and homogenous.

Notwithstanding the prior art, the present invention is neither taught nor rendered obvious thereby.

### SUMMARY OF THE INVENTION

The present invention is a three dimensional cake sculpture product. The term “cake sculpture” refers to any cake that has a sculpture presentation. “Cake” means a product that is made from batter and is baked.

The present invention product includes: a.) an edible baked base having a bottom; substantially vertical walls, and a non-vertical top; and, b.) an edible three dimensional sculpture presenting a distinguishable scene, the sculpture has two portions, being a first portion and a second portion. The first portion is three dimensional and is located on the non-vertical top of the base, and the second portion is two dimensional and is located on the substantially vertical walls of the base. In some preferred embodiments, the second portion includes at least one edible substrate and at least one edible printed segment of the distinguishable scene on the substrate.

In some preferred embodiments of the present invention three dimensional cake sculpture product, the first portion is selected from the group consisting of cake icing, cookies, wafers, jelly beans, candy and combinations thereof positioned to create a segment of the distinguishable scene.

In some preferred embodiments, the distinguishable scene is a head presentation of a stylized person, e.g., a head presentation of a stylized person including a top as the first portion and facial features as the second portion. The top may be selected from the group of three dimensional tops, consisting of hair, ears, headwear and combinations thereof.

In other embodiments of the present invention three dimensional cake sculpture product, the distinguishable scene is at least a part of a stylized animal.

In other embodiments, the present invention three dimensional cake sculpture product includes an edible baked base and a three dimensional sculpture presenting a distinguishable scene, the sculpture being of two portions, the first portion being edible and being three dimensional and being located on the non-vertical top of the base, and the second portion being inedible and being two dimensional and being located on the substantially vertical walls. In some embodiments, the second portion includes at least one inedible substrate and at least one inedible printed segment of the distinguishable scene on the substrate.

The present invention also relates to a method of making a three dimensional cake sculpture product. The method includes the steps of a.) making an edible baked base in a shape having a bottom, substantially vertical walls and a non-vertical top; and b.) creating a three dimensional sculpture of a distinguishable scene on the base by applying a first portion of the sculpture to the top of the base in the form of a three dimensional portion of the sculpture, and applying a second portion of the sculpture to the substantially vertical walls in a flat, smooth, two dimensional outer surface. In some embodiments, the second portion is an edible portion having an edible substrate and at least one edible printed segment of the distinguishable scene on the substrate. In other embodiments, the second portion is an inedible peelable portion containing at least one printed segment of the distinguishable scene.

For example, the methods may include the sculpture being created by applying at least one application of cake icing and at least a second application of a decoration selected from the group consisting of another cake icing, cookies, wafers, jelly beans, candy and combinations thereof. The edible baked base may be made by baking in a baking pan having a predetermined shape to create the bottom of the substantially vertical walls, and the non-vertical top or it could be cut or shaped after being baked.

### BRIEF DESCRIPTION OF THE DRAWINGS

The present invention should be more fully understood when the specification herein is taken in conjunction with the drawings appended hereto wherein:

FIGS. 1, 2, 3, and 4 show a front view of various children's busts in the form of sculptured cake;

FIGS. 5, 6, 7, and 8 show present invention cakes with sculptured animal presentations;

FIGS. 9, 10, 11, 12, 13, 14, 15, and 16 illustrate present invention sculptured cakes with holiday themes, including 4^{th} of July, Halloween, Christmas, Easter, and Thanksgiving;

FIG. 17 shows a happy clown birthday present invention sculptured cake;

FIG. 18 shows present invention sculptured cake in the form of an animal with horns;

FIGS. 19, 20, 21, and 22 show present invention sculptured cupcakes with smiling children;

FIGS. 23, 24, 25, 26, 27, 28, 29, and 30 show various sculptured animal cakes;

FIGS. 31 and 32 show a porpoise and a crab underwater as present invention sculptured cakes;

FIGS. 33, 34, 35, and 36 show sculptured animal cakes;

FIGS. 37 and 38 show sculptured Halloween scary cakes;

FIGS. 39, 40, 41, 42, and 43 illustrate sculptured animal cakes;.

FIG. 44 shows a vampire sculptured cake;

FIGS. 45, 46, 47, 48, 49, and 50 illustrate various pests and bugs as sculptured cakes;

FIGS. 51 and 52 show fire truck and train action three dimensional cake sculptures;

FIGS. 53 and 54 illustrate three dimensional sculptured sport cakes;

FIGS. 55 and 56 illustrate present invention cakes with children's fantasy sculpture; and,

FIGS. 57, 58, 59, and 60 show three dimensional sports cupcakes.

### DETAILED DESCRIPTION OF THE PRESENT INVENTION

The present invention cakes present exciting sculptures to children and adults in a new form never before used. The cakes have flat (two dimension) printed presentations on their sides and three dimensional sculptures on their tops wherein the tops and sides together complete a single scene. Now that the invention has been disclosed, an infinite number of possibilities emerge. The following examples illustrate the invention.

FIG. 1 shows a sculptured cake 1 with a child's head with a baseball cap. Sculptured cake 1 has a top 2 in the form of a three dimensional baseball cap made of frosting. It includes jelly bean button 3 and a cookie visor 4. The sidewall 5 has a printed paper wrap with face 6 printed thereon. It extends from top 2 down to bottom 7. In this embodiment, the sidewall 5 is inedible, although it could readily be an edible film wrap with edible film print thereon. Edible film is well known for dissolvable mint strips and edible print has been used on lollypops for decades.

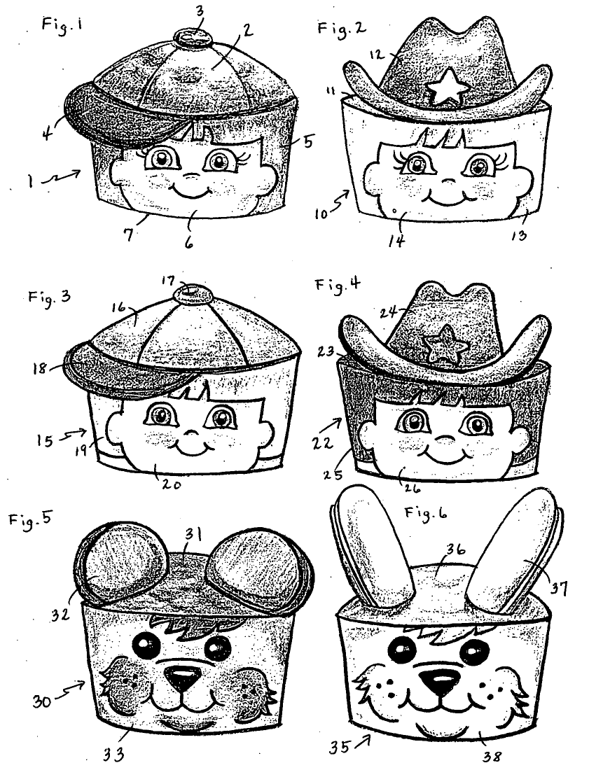

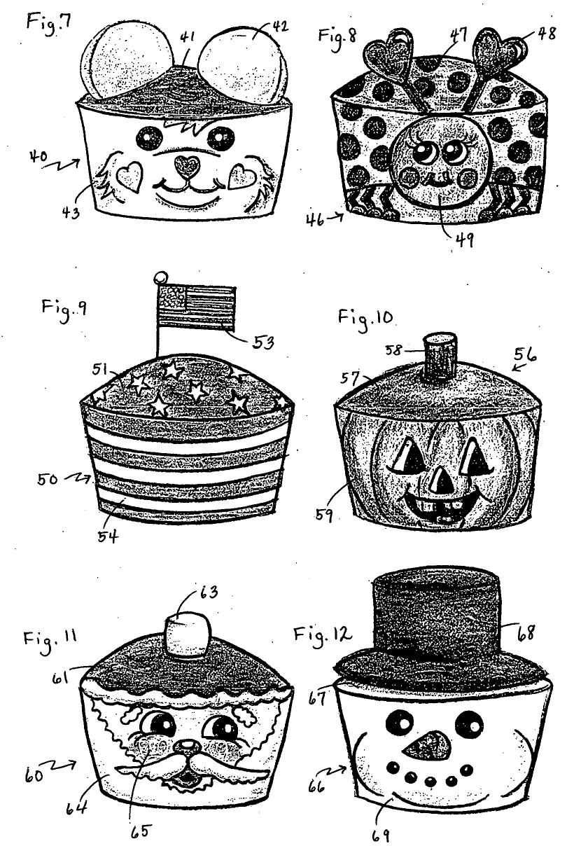

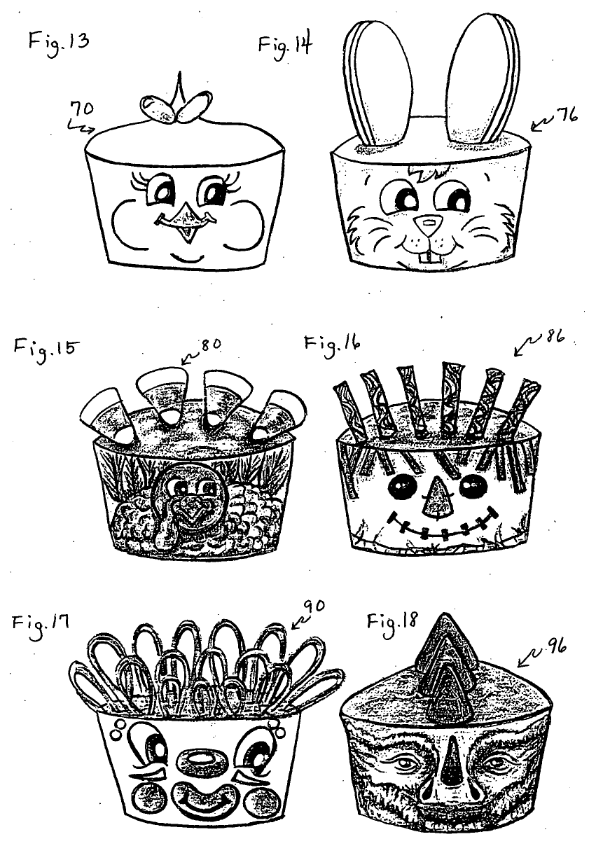

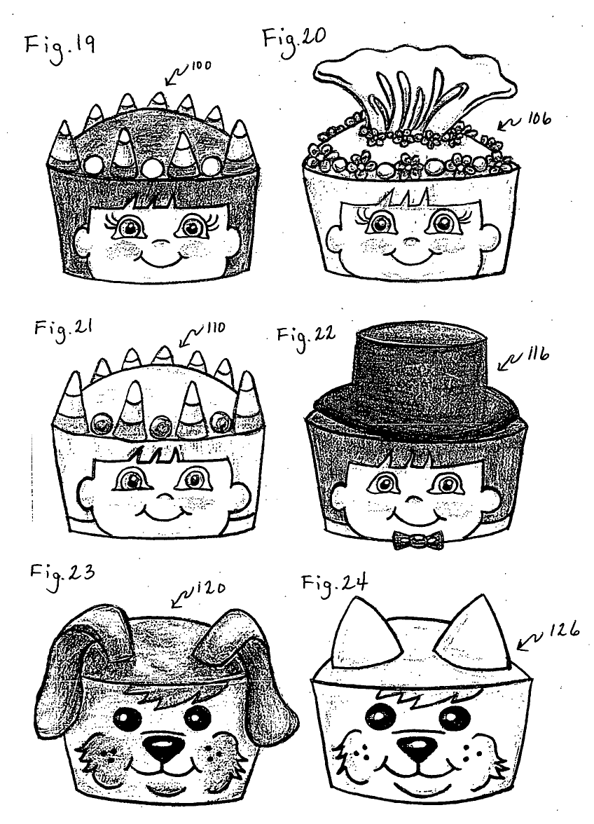

FIG. 2 shows present invention sculptured cake 10 with a molded sheriff's hat 12 on top 11 and an edible face 14 on substantially vertical sidewall 13.

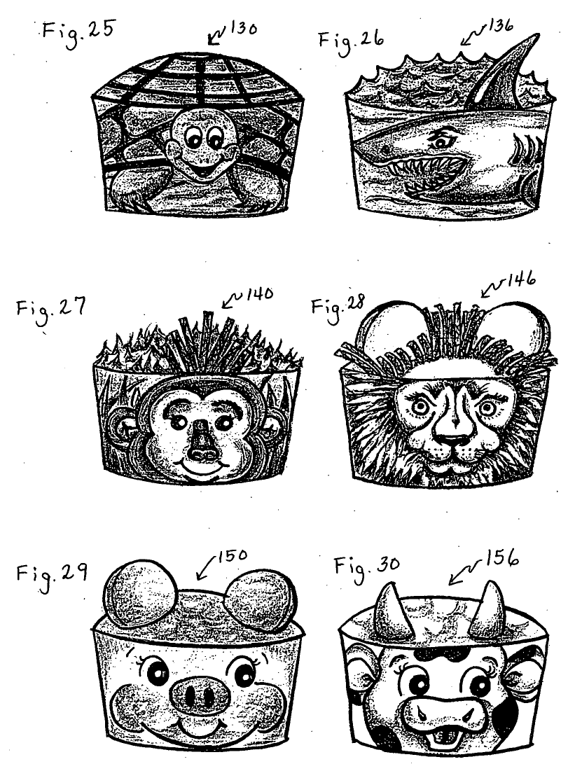

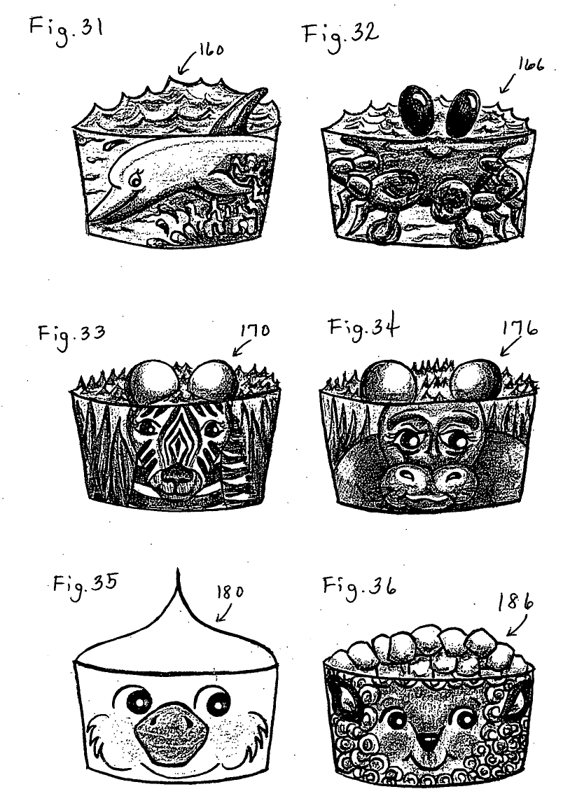

FIG. 3 shows a sculptured cupcake with top 16 in the form of blue molded frosting with a butter rum button 17 and a cookie visor 18.

Sidewall 19 includes a face representation 20.

FIG. 4 shows another present invention sculptured cake 22 with a top 23 and a sheriff's hat 24, with an edible strip 25 with a printed child's face and hair 26.

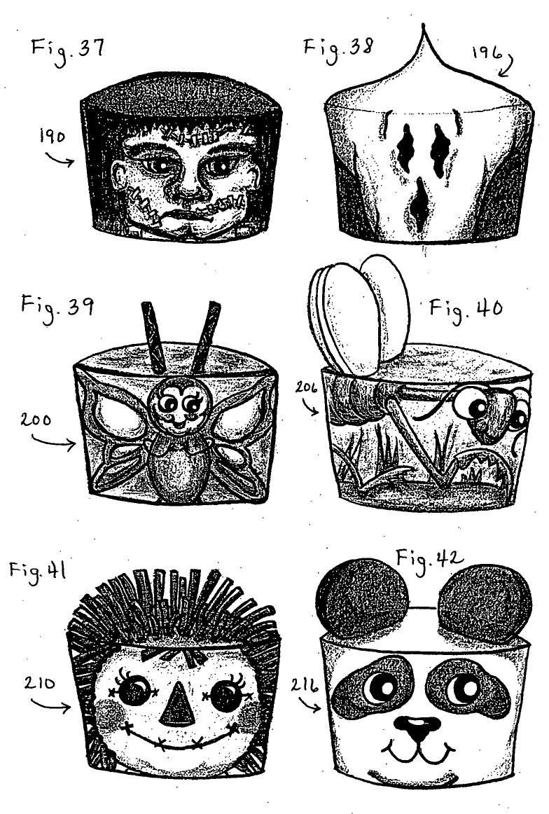

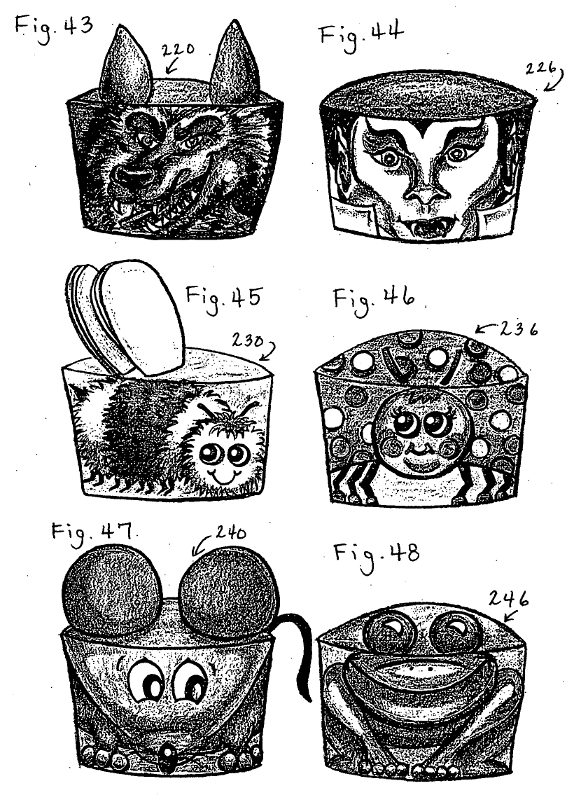

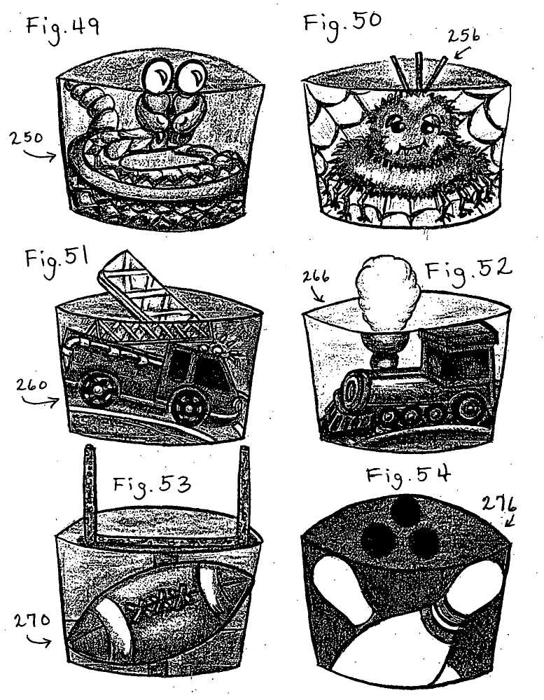

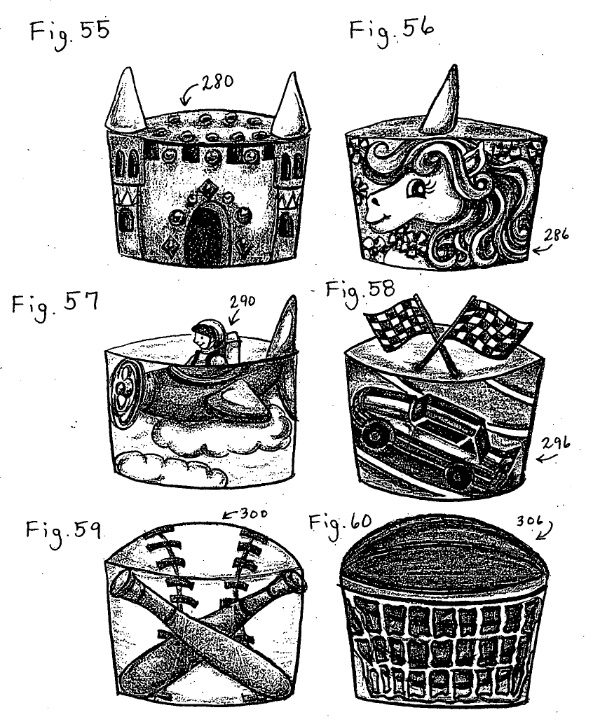

FIG. 5 shows present invention sculptured cake bear 30 with cookie ears 32 on top 31 and a bear face on sidewall printed sheet 33.

FIG. 6 shows present invention sculptured cake rabbit 35 with cookie ears 37 on top 36 and a rabbit face on sidewall printed sheet 38.

FIG. 7 shows a valentine's cub present invention sculptured cake 40 with top 41 and ears such as cookie 42, and sidewall printed sheet 43.

FIG. 8 present invention sculptured cake 46 with top 47 and lollipop antennas 48, and with printed edible sidewall sheet 49 to collectively create a ladybug.

FIG. 9 shows a cupcake 50 with stars and a blue background top 51 with flag 53. Sidewall 54 includes a printed edible gel sheet 54 with red and white flag stripes.

FIG. 10 shows present invention sculptured cake pumpkin 56 with top 57 having a stem 58 (e.g. a root beer barrel) and sidewall 59 in the form of an edible pumpkin face.

FIG. 11 shows a present invention sculptured cake Santa 60 with top hat 61 and marshmallow 63 and a sidewall 64 that is an edible film with a Santa face 65 printed thereon.

FIG. 12 shows present invention sculptured cake snowman 66 with top 67 and candy molded top hat 68 and a printed sidewall sheet 69 with a snowman face printed thereon.

FIGS. 13, 14, 15, 16, 17, 18, 19, 20, 21, 22, 23, and 24 show present invention sculptured cakes 70, 76, 80, 86, 90, 96, 100, 106, 110, 116, 120, and 126, all showing various sculptured presentations with sidewall sheets with two dimensional printing and tops with three dimensional sculptured creations utilizing such edibles as molded or shaped icing, jelly beans, wafers, candy corns, pretzel sticks, string candy, chocolate kisses, flowers, sugars, beads and other edible components.

FIGS. 25, 26, 27, 28, 29, and 30 show present invention sculptured cakes 130, 136, 140, 146, 150, and 156, all showing various sculptured presentations with animals.

FIGS. 31 and 32 show present invention sculptured cakes 160 and 166 of a porpoise and a crab underwater, respectively.

FIGS. 33, 34, 35, and 36 show present invention sculptured cakes 170, 176, 180, and 186 of various animals.

FIGS. 37 and 38 show present invention sculptured cakes 190, and 196 of Halloween scary designs.

FIGS. 39, 40, 41, 42, and 42 show present invention sculptured cakes 200, 206, 210, 216, and 220 of various animals.

FIG. 44 shows a present invention sculptured cake 226 of a vamp ire.

FIGS. 45, 46, 47, 48, 49, and 50 show present invention sculptured cakes 230, 236, 240, 246, 250, and 256 of various pests and bugs.

FIGS. 51 and 52 show present invention sculptured cakes 260, and 266 of a fire truck and train engine, respectively.

FIGS. 53 and 54 show present invention three dimensional sculptured cakes 270 and 276 of various sports.

FIGS. 55 and 56 show present invention sculptured cakes 280 and 286 of various children's fantasies.

FIGS. 57, 58, 59, and 60 show present invention three dimensional sculptured cupcakes 290, 296, 300, and 306 of various sports.

Obviously, numerous modifications and variations of the present invention are possible in light of the above teachings. It is therefore understood that within the scope of the appended claims, the invention may be practiced otherwise than as specifically described herein.

1. A three dimensional cake sculpture product, which comprises:
a.) an edible baked base having a bottom, substantially vertical walls, and a non-vertical top;
b.) an edible three dimensional sculpture presenting a distinguishable scene, said sculpture being of two portions, being a first portion and a second portion, said first portion being three dimensional and being located on said non-vertical top of said base, and said second portion being two dimensional and being located on said substantially vertical walls.

2. The three dimensional cake sculpture product of claim 1 wherein said second portion includes at least one edible substrate and at least one edible printed segment of said distinguishable scene on said substrate.

3. The three dimensional cake sculpture product of claim 1 wherein said first portion is selected from the group consisting of cake icing, cookies, wafers, jelly beans, candy and combinations thereof positioned to create a segment of said distinguishable scene.

4. The three dimensional cake sculpture product of claim 1 wherein said distinguishable scene is a head presentation of a stylized person.

5. The three dimensional cake sculpture product of claim 4 wherein said head presentation of a stylized person includes a top as said first portion and facial features as said second portion.

6. The three dimensional cake sculpture product of claim 5 wherein said top is selected from the group of three dimensional tops, consisting of hair, ears, headwear and combinations thereof.

7. The three dimensional cake sculpture product of claim 1 wherein said distinguishable scene is at least a part of a stylized animal.

8. A three dimensional cake sculpture product, which comprises:
a.) an edible baked base having a bottom, substantially vertical walls, and a non-vertical top;
b.) a three dimensional sculpture presenting a distinguishable scene, said sculpture being of two portions, being a first portion and a second portion, said first portion being edible and being three dimensional and being located on said non-vertical top of said base, and said second portion being inedible, being two dimensional and being located on said substantially vertical walls.

9. The three dimensional cake sculpture product of claim 8 wherein said second portion is an inedible, peelable portion containing at least one printed segment of said distinguishable scene on said substrate.

10. The three dimensional cake sculpture product of claim 8 wherein said first portion is selected from the group consisting of cake icing, cookies, wafers, jelly beans, candy and combinations thereof positioned to create a segment of said distinguishable scene.

11. The three dimensional cake sculpture product of claim 8 wherein said distinguishable scene is a head presentation of a stylized person.

12. The three dimensional cake sculpture product of claim 11 wherein said head presentation of a stylized person includes a top as said first portion and facial features as said second portion.

13. The three dimensional cake sculpture product of claim 12 wherein said top is selected from the group of three dimensional tops, consisting of hair, ears, headwear and combinations thereof.

14. The three dimensional cake sculpture product of claim 8 wherein said distinguishable scene is at least a part of a stylized animal.

15. A method of making a three dimensional cake sculpture product, which comprises:
a.) making an edible baked base in a shape having a bottom, substantially vertical walls and a non-vertical top;
b.) creating a three dimensional sculpture of a distinguishable scene on said base by applying a first portion of said sculpture to said top of said base in the form of a three dimensional portion of said sculpture, and applying a second portion of said sculpture to said substantially vertical walls in a flat, smooth, two dimensional outer surface.

16. The method of claim 15 wherein said second portion is an edible portion having an edible substrate and at least one edible printed segment of said distinguishable scene on said substrate.

17. The method of claim 15 wherein said second portion is an inedible peelable portion containing at least one printed segment of said distinguishable scene.

18. The method of claim 15 wherein said first portion of said sculpture is created by applying at least one application of cake icing and at least a second application of a decoration selected from the group consisting of another cake icing, cookies, wafers, jelly beans, candy and combinations thereof.

19. The method of claim 15 wherein said edible baked base is made by baking in a baking pan having a predetermined shape to create said bottom said substantially vertical walls, and said non-vertical top.

20. The method of claim 15 wherein said distinguishable scene is selected from the group consisting of at least a portion of a stylized person, and at least a portion of a stylized animal.
